(19) United States
(12) Patent Application Publication
(10) Pub. No.: US 2025/0152311 A1
(43) Pub. Date: May 15, 2025

(54) ALIGNERS WITH ENHANCED GABLE BENDS

(71) Applicant: Align Technology, Inc., San Jose, CA (US)

(72) Inventor: Peter Webber, Redwood City, CA (US)

(21) Appl. No.: 19/025,779

(22) Filed: Jan. 16, 2025

Related U.S. Application Data
(63) Continuation of application No. 17/497,833, filed on Oct. 8, 2021, now Pat. No. 12,251,287.
Application No. 17/497,833 is a continuation of application No. 15/845,144, filed on Dec. 18, 2017, now Pat. No. 11,166,788.
(60) Provisional application No. 62/436,042, filed on Dec. 19, 2016.

(51) Int. Cl. A61C 7/08; A61C 7/00; A61C 7/12

(52) U.S. Cl. CPC A61C 7/08; A61C 7/002; A61C 7/12

(57) ABSTRACT

Systems, methods, and devices for improved orthodontic treatment of a patient's teeth are provided herein. In some aspects, a method for fabricating an orthodontic appliance for treating a patient's teeth is disclosed. The method may comprise determining a movement path to move a tooth from an initial arrangement towards a target arrangement; determining a force system to move the tooth along the movement path; determining a variable gable bend to produce the force system; determining a geometry for a tooth receiving cavity of the appliance based on the variable gable bend; and generating instructions for fabricating the appliance having a tooth receiving cavity formed according to the geometry for the tooth receiving cavity.

### CROSS-REFERENCE

This application is a continuation of U.S. application Ser. No. 17/497,833 filed Oct. 8, 2021, which is a continuation of U.S. application Ser. No. 15/845,144, filed Dec. 18, 2017, now U.S. Pat. No. 11,166,788, issued Nov. 11, 2021, which claims the benefit of U.S. Provisional Application No. 62/436,042, filed Dec. 19, 2016, which application is incorporated herein by reference.

### BACKGROUND

Prior orthodontic procedures typically involve repositioning a patient's teeth to a desired arrangement in order to correct malocclusions and/or improve aesthetics. To achieve these objectives, orthodontic appliances such as braces, retainers, shell aligners, and the like can be applied to the patient's teeth by an orthodontic practitioner. The appliance can be configured to exert force on one or more teeth in order to effect desired tooth movements. The application of force can be periodically adjusted by the practitioner (e.g., by altering the appliance or using different types of appliances) in order to incrementally reposition the teeth to a desired arrangement.

The prior orthodontic methods and apparatus to move teeth can be less than ideal in at least some respects. In light of the above, improved orthodontic appliances are needed. Ideally such appliances would provide more accurate tooth movement with improved control over the forces applied to the teeth.

### SUMMARY

Improved systems, methods, and devices for repositioning a patient's teeth are provided herein. In some aspects, a method for fabricating an orthodontic appliance for treating a patient's teeth is disclosed. The method may comprise determining a movement path to move a tooth from an initial arrangement towards a target arrangement; determining a force system to move the tooth along the movement path; determining a variable gable bend to produce the force system; determining a geometry for a tooth receiving cavity of the appliance based on the variable gable bend; and generating instructions for fabricating the appliance having a tooth receiving cavity formed according to the geometry for the tooth receiving cavity.

In some embodiments, the variable gable bend includes a variable rotation about a center of rotation along the axis. In some embodiments, the amount of variable rotation increases linearly as a function of radial distance from the center of rotation. An axis may extend between the root and occlusal surface of the tooth and an amount of rotation increases linearly as a function of radial distance from the center of rotation. The variable gable bend may include a translation of the shape of the tooth receiving cavity that varies along the tooth receiving cavity. The axis may extend between the root and occlusal surface of the tooth and the variable gable bend may include a translation of the shape of the tooth receiving cavity that varies along axis. The variable gable bend may include a first portion and a second portion, wherein the first portion includes a shape based variable gable bend and the shape of the second portion does not include a gable bend and is not rotated or shifted. The center of rotation may be at a gingival portion of a tooth receiving cavity. The center of rotation may be outside the tooth receiving cavity.

In some embodiments, the appliance may be first appliance and the variable gable bend may be about a first center of rotation and the method may further include determining a second force system to move the tooth along the movement path; determining a second center of rotation, different than the first center of rotation; determining second variable gable bend to produce the second force system; determining a second geometry for a second tooth receiving cavity of a second appliance based on the second variable gable bend; and generating instructions for fabricating the second appliance having the second tooth receiving cavity formed according to the second geometry for the second tooth receiving cavity; wherein the first appliance and the second appliance are part of a set of appliances.

In some aspects, a system for fabricating an orthodontic appliance for treating a patient's teeth is disclosed. The system may comprise one or more processors configured with instructions to: determine a movement path to move a tooth from an initial arrangement to a target arrangement; determine a force system to move the tooth along the movement path; determine variable gable bend to produce the force system; determine a geometry for a tooth receiving cavity of an appliance based on the variable gable bend; and generate instructions for fabricating an appliance having a tooth receiving cavity formed according to the geometry for the tooth receiving cavity.

In some embodiments, the variable gable bend may include a variable rotation about a center of rotation. An amount of variable rotation may increase linearly as a function of radial distance from the center of rotation. An axis may extend between the root and occlusal surface of the tooth and an amount of variable rotation may increase linearly as a function of radial distance from the center of rotation. The variable gable bend may include a translation of the shape of the tooth receiving cavity that varies along the tooth receiving cavity. An axis may extend between the root and occlusal surface of the tooth and the variable gable bend may include a translation of the shape of the tooth receiving cavity that varies along axis. The variable gable bend may include a first portion and a second portion, wherein the first portion includes a variable gable bend and the second portion does not include a gable bend and is not rotated or shifted. The first center of rotation may be at a gingival portion of the first tooth receiving cavity. The first center of rotation may be outside the first tooth receiving cavity.

In some embodiments, the appliance is a first appliance and the variable gable bend is about a first center of rotation and the system is further configured to determine a second force system to move the tooth along the movement path; determine a second center of rotation, different than the first center of rotation; determine second variable gable bend to produce the second force system; determine a second geometry for a second tooth receiving cavity of a second appliance based on the second variable gable bend; and generate instructions for fabricating the second appliance having the second tooth receiving cavity formed according to the second geometry for the second tooth receiving cavity; wherein the first appliance and the second appliance are part of a set of appliances.

In some aspects, an apparatus for repositioning at least one tooth of a patient is disclosed. The apparatus may comprise an appliance including a plurality of tooth receiving cavities and being configured to move the tooth from a first position towards a second position; a first of the tooth receiving cavities having a geometry to impart a force system on the tooth to move the tooth towards the second position, wherein the geometry for the first of the tooth receiving cavities of the appliance includes variable gable bend.

In some embodiments, the variable gable bend may include a variable rotation about a center of rotation. An amount of variable rotation may increase linearly as a function of radial distance from the center of rotation. An axis may extend between the root and occlusal surface of the tooth and an amount of rotation may increase linearly as a function of radial distance from the center of rotation along the axis. The variable gable bend may include a translation of the shape of the tooth receiving cavity that varies along the tooth receiving cavity. An axis may extend between the root and occlusal surface of the tooth and the variable gable bend may include a translation of the shape of the tooth receiving cavity that varies along axis. The variable gable bend may include a first portion and a second portion, wherein the first portion includes a shape based variable gable bend and the shape of the second portion conforms to the shape of the tooth. The center of rotation may be at a gingival portion of a tooth receiving cavity. The center of rotation may be outside the tooth receiving cavity.

Other objects and features of the present invention will become apparent by a review of the specification, claims, and appended figures.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates a tooth repositioning appliance, in accordance with embodiments;

FIG. 1B illustrates a tooth repositioning system, in accordance with embodiments;

FIG. 1C illustrates a method of orthodontic treatment using a plurality of appliances, in accordance with embodiments;

FIG. 2 illustrates a method for designing an orthodontic appliance, in accordance with embodiments;

FIG. 3 illustrates a method for digitally planning an orthodontic treatment, in accordance with embodiments;

FIG. 4 is a simplified block diagram of a data processing system, in accordance with embodiments;

FIG. 5 illustrates an appliance with a fixed gable bend, in accordance with embodiments;

FIG. 6 illustrates an appliance with a variable gable bend, in accordance with embodiments;

FIGS. 7A-7C illustrate a variable gable bend, in accordance with embodiments;

FIGS. 8A-8B illustrate a variable gable bend, in accordance with embodiments; and

FIGS. 9A-9B illustrate a variable gable bend, in accordance with embodiments.

### DETAILED DESCRIPTION

A better understanding of the features and advantages of the present disclosure will be obtained by reference to the following detailed description that sets forth illustrative embodiments, in which the principles of embodiments of the present disclosure are utilized, and the accompanying drawings.

Although the detailed description contains many specifics, these should not be construed as limiting the scope of the disclosure but merely as illustrating different examples and aspects of the present disclosure. It should be appreciated that the scope of the disclosure includes other embodiments not discussed in detail herein. Various other modifications, changes, and variations which will be apparent to those skilled in the art may be made in the arrangement, operation, and details of the methods, systems, and apparatus of the present disclosure provided herein without departing from the spirit and scope of the invention as described herein.

As used herein the terms “dental appliance,” “orthodontic appliance,” and “tooth receiving appliance” are treated synonymously.

As used herein the terms “rigid” and “stiff” are treated synonymously.

As used herein the term “and/or” is used as a functional word to indicate that two words or expressions are to be taken together or individually. For example, A and/or B encompasses A alone, B alone, and A and B together.

As used herein the terms “torque” and “moment” are treated synonymously.

As used herein a “moment” encompasses a force acting on an object such as a tooth at a distance from a center of resistance. The moment may be calculated with a vector cross product of a vector force applied to a location corresponding to a displacement vector from the center of resistance, for example. The moment may comprise a vector pointing in a direction. A moment opposing another moment may encompass one of the moment vectors oriented toward a first side of the object such as the tooth and the other moment vector oriented toward an opposite side of the object such as tooth, for example. Any discussion herein referring to application of forces on a patient's teeth is equally applicable to application of moments on the teeth, and vice-versa.

As used herein a “plurality of teeth” encompasses two or more teeth. In some embodiments, one or more posterior teeth comprises one or more of a molar, a premolar or a canine, and one or more anterior teeth comprising one or more of a central incisor, a lateral incisor, a cuspid, a first bicuspid or a second bicuspid.

The present disclosure provides orthodontic systems and related methods for designing and providing improved or more effective tooth moving systems for eliciting a desired tooth movement and/or repositioning teeth into a desired arrangement.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with the polymeric shell appliances as disclosed herein.

The embodiments disclosed herein are well suited for moving one or more teeth of the first group of one or more teeth or moving one or more of the second group of one or more teeth, and combinations thereof.

The embodiments disclosed herein are well suited for combination with one or more known commercially available tooth moving components such as attachments and polymeric shell appliances. In some embodiments, the appliance and one or more attachments are configured to move one or more teeth along a tooth movement vector comprising six degrees of freedom, in which three degrees of freedom are rotational and three degrees of freedom are translation.

The present disclosure provides orthodontic appliances and related systems, methods, and devices. Repositioning of teeth may be accomplished with the use of a series of removable elastic positioning appliances such as the Invisalign® system available from Align Technology, Inc., the assignee of the present disclosure. Such appliances may have a thin shell of elastic material that generally conforms to a patient's teeth but is slightly out of alignment with an initial or immediately prior tooth configuration. Placement of the appliance over the teeth applies controlled forces in specific locations to gradually move the teeth into the new configuration. Repetition of this process with successive appliances comprising new configurations eventually moves the teeth through a series of intermediate configurations or alignment patterns to a final desired configuration.

Although reference is made to an appliance comprising a polymeric shell appliance, the embodiments disclosed herein are well suited for use with many appliances that receive teeth, for example appliances without one or more of polymers or shells. The appliance can be fabricated with one or more of many materials such as metal, glass, reinforced fibers, carbon fiber, composites, reinforced composites, aluminum, biological materials, and combinations thereof for example. The appliance can be shaped in many ways, such as with thermoforming or direct fabrication as described herein, for example. Alternatively or in combination, the appliance can be fabricated with machining, such as an appliance fabricated from a block of material with computer numeric control machining.

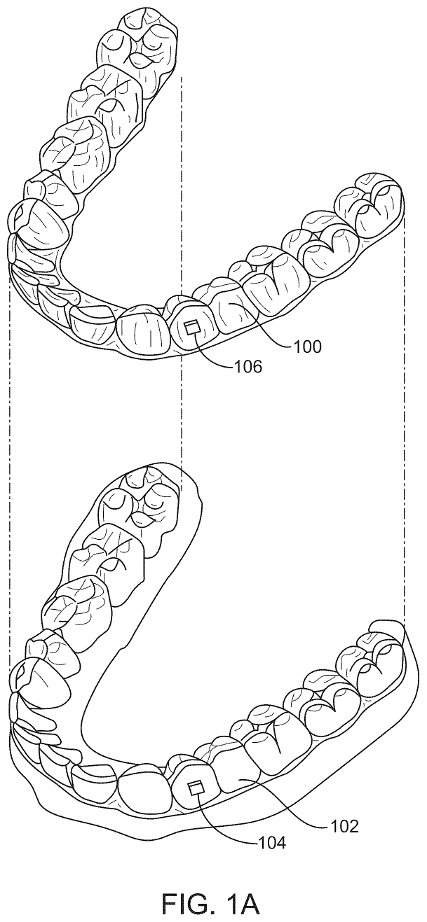

Turning now to the drawings, in which like numbers designate like elements in the various figures, FIG. 1A illustrates an exemplary tooth repositioning appliance or aligner 100 that can be worn by a patient in order to achieve an incremental repositioning of individual teeth 102 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

Optionally, in cases involving more complex movements or treatment plans, it may be beneficial to utilize auxiliary components (e.g., features, accessories, structures, devices, components, and the like) in conjunction with an orthodontic appliance. Examples of such accessories include, but are not limited to, elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems, and methods described herein include improved orthodontic appliances with integrally formed features that are shaped to couple to such auxiliary components, or that replace such auxiliary components.

FIG. 1B illustrates a tooth repositioning system 110 including a plurality of appliances 112, 114, 116. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement towards a target tooth arrangement by placing a series of incremental position adjustment appliances over the patient's teeth. For example, the tooth repositioning system 110 can include a first appliance 112 corresponding to an initial tooth arrangement, one or more intermediate appliances 114 corresponding to one or more intermediate arrangements, and a final appliance 116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 1C illustrates a method 150 of orthodontic treatment using a plurality of appliances, in accordance with embodiments. The method 150 can be practiced using any of the appliances or appliance sets described herein. In step 160, a first orthodontic appliance is applied to a patient's teeth in order to reposition the teeth from a first tooth arrangement to a second tooth arrangement. In step 170, a second orthodontic appliance is applied to the patient's teeth in order to reposition the teeth from the second tooth arrangement to a third tooth arrangement. The method 150 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The various embodiments of the orthodontic appliances presented herein can be fabricated in a wide variety of ways. In some embodiments, the orthodontic appliances herein (or portions thereof) can be produced using direct fabrication, such as additive manufacturing techniques (also referred to herein as “3D printing) or subtractive manufacturing techniques (e.g., milling). In some embodiments, direct fabrication involves forming an object (e.g., an orthodontic appliance or a portion thereof) without using a physical template (e.g., mold, mask etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

In some embodiments, the direct fabrication methods provided herein build up the object geometry in a layer-by-layer fashion, with successive layers being formed in discrete build steps. Alternatively or in combination, direct fabrication methods that allow for continuous build-up of an object's geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

The direct fabrication approaches provided herein are compatible with a wide variety of materials, including but not limited to one or more of the following: polymer matrix reinforced with ceramic or metallic polymers, a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof. The materials used for direct fabrication can be provided in an uncured form (e.g., as a liquid, resin, powder, etc.) and can be cured (e.g., by photopolymerization, light curing, gas curing, laser curing, crosslinking, etc.) in order to form an orthodontic appliance or a portion thereof. The properties of the material before curing may differ from the properties of the material after curing. Once cured, the materials herein can exhibit sufficient strength, stiffness, durability, biocompatibility, etc. for use in an orthodontic appliance. The post-curing properties of the materials used can be selected according to the desired properties for the corresponding portions of the appliance.

In some embodiments, relatively rigid portions of the orthodontic appliance can be formed via direct fabrication using one or more of the following materials: a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, and/or a polytrimethylene terephthalate.

In some embodiments, relatively elastic portions of the orthodontic appliance can be formed via direct fabrication using one or more of the following materials: a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, and/or a thermoplastic polyamide elastomer.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step using the same fabrication machine and method. For instance, a multi-tip extrusion apparatus can be used to selectively dispense multiple types of materials (e.g., resins, liquids, solids, or combinations thereof) from distinct material supply sources in order to fabricate an object from a plurality of different materials. Such methods are described in U.S. Pat. No. 6,749,414, the disclosure of which is incorporated herein by reference in its entirety. Alternatively or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed. The relative arrangement of the first and second portions can be varied as desired, e.g., the first portion can be partially or wholly encapsulated by the second portion of the object. The sequential manufacturing steps can be performed using the same fabrication machine or different fabrication machines and can be performed using the same fabrication method or different fabrication methods. For example, a sequential multi-manufacturing procedure can involve forming a first portion of the object using stereolithography and a second portion of the object using fused deposition modeling.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every n^{th} build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, reduced variability in appliance accuracy and residual stress can be achieved.

In many embodiments, environmental variables (e.g., temperature, humidity, Sunlight or exposure to other energy/curing source) are maintained in a tight range to reduce variable in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

Although various embodiments herein are described with respect to direct fabrication techniques, it shall be appreciated that other techniques can also be used, such as indirect fabrication techniques. In some embodiments, the appliances herein (or portions thereof) can be produced using indirect fabrication techniques, such as by thermoforming over a positive or negative mold. Indirect fabrication of an orthodontic appliance can involve one or more of the following steps: producing a positive or negative mold of the patient's dentition in a target arrangement (e.g., by additive manufacturing, milling, etc.), thermoforming one or more sheets of material over the mold in order to generate an appliance shell, forming one or more structures in the shell (e.g., by cutting, etching, etc.), and/or coupling one or more components to the shell (e.g., by extrusion, additive manufacturing, spraying, thermoforming, adhesives, bonding, fasteners, etc.). Optionally, one or more auxiliary appliance components as described herein (e.g., elastics, wires, springs, bars, arch expanders, palatal expanders, twin blocks, occlusal blocks, bite ramps, mandibular advancement splints, bite plates, pontics, hooks, brackets, headgear tubes, bumper tubes, palatal bars, frameworks, pin-and-tube apparatuses, buccal shields, buccinator bows, wire shields, lingual flanges and pads, lip pads or bumpers, protrusions, divots, etc.) are formed separately from and coupled to the appliance shell (e.g., via adhesives, bonding, fasteners, mounting features, etc.) after the shell has been fabricated.

In some embodiments, the orthodontic appliances herein can be fabricated using a combination of direct and indirect fabrication techniques, such that different portions of an appliance can be fabricated using different fabrication techniques and assembled in order to form the final appliance. For example, an appliance shell can be formed by indirect fabrication (e.g., thermoforming), and one or more structures or components as described herein (e.g., auxiliary components, power arms, etc.) can be added to the shell by direct fabrication (e.g., printing onto the shell).

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled additive manufacturing such as 3D printing, etc.). The computer-based methods presented herein can improve the accuracy, flexibility, and convenience of appliance fabrication.

In some embodiments, computer-based 3-dimensional planning/design tools, such as Treat™ software from Align Technology, Inc., may be used to design and fabricate the orthodontic appliances described herein.

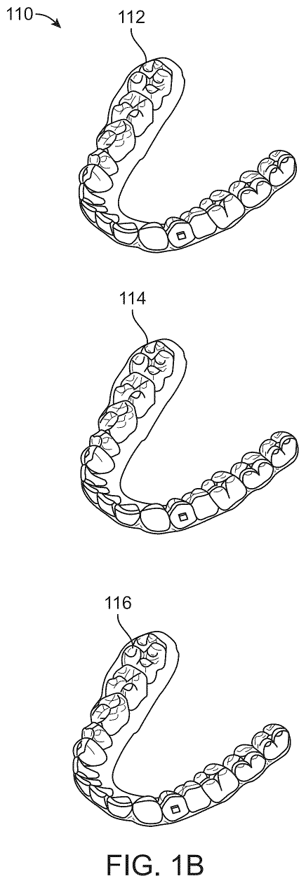

FIG. 2 illustrates a method 200 for designing an orthodontic appliance to be fabricated, in accordance with embodiments. The method 200 can be applied to any embodiment of the orthodontic appliances described herein. Some or all of the steps of the method 200 can be performed by any suitable data processing system or device, e.g., one or more processors configured with suitable instructions.

In step 210, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In step 220, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, step 220 can involve determining a particular type of force to be applied (e.g., extrusive force, intrusive force, translational force, rotational force, tipping force, torqueing force, etc.) without calculating the specific magnitude and/or direction of the force.

In step 230, an appliance geometry and/or material composition for an orthodontic appliance configured to produce the force system is determined. The appliance can be any embodiment of the appliances discussed herein, such as an appliance having variable localized properties, integrally formed components, and/or power arms.

For example, in some embodiments, the appliance comprises a heterogeneous thickness, a heterogeneous stiffness, or a heterogeneous material composition. In some embodiments, the appliance comprises two or more of a heterogeneous thickness, a heterogeneous stiffness, or a heterogeneous material composition. In some embodiments, the appliance comprises a heterogeneous thickness, a heterogeneous stiffness, and a heterogeneous material composition. The heterogeneous thickness, stiffness, and/or material composition can be configured to produce the force system for moving the teeth, e.g., by preferentially applying forces at certain locations on the teeth. For example, an appliance with heterogeneous thickness can include thicker portions that apply more force on the teeth than thinner portions. As another example, an appliance with heterogeneous stiffness can include stiffer portions that apply more force on the teeth than more elastic portions. Variations in stiffness can be achieved by varying the appliance thickness, material composition, and/or degree of photopolymerization, as described herein.

In some embodiments, determining the appliance geometry and/or material composition comprises determining the geometry and/or material composition of one or more integrally formed components to be directly fabricated with an appliance shell. The integrally formed component can be any of the embodiments described herein. The geometry and/or material composition of the integrally formed component(s) can be selected to facilitate application of the force system onto the patient's teeth. The material composition of the integrally formed component can be the same as or different from the material composition of the shell.

In some embodiments, determining the appliance geometry comprises determining the geometry for a variable gable bend.

The step 230 can involve analyzing the desired force system in order to determine an appliance geometry and material composition that would produce the force system. In some embodiments, the analysis involves determining appliance properties (e.g., stiffness) at one or more locations that would produce a desired force at the one or more locations. The analysis can then involve determining an appliance geometry and material composition at the one or more locations to achieve the specified properties. Determination of the appliance geometry and material composition can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more appliance geometries and material compositions can be selected for testing or force modeling. As noted above, a desired tooth movement, as well as a force system required or desired for eliciting the desired tooth movement, can be identified. Using the simulation environment, a candidate appliance geometry and composition can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

Optionally, step 230 can further involve determining the geometry of one or more auxiliary components to be used in combination with the orthodontic appliance in order to exert the force system on the one or more teeth. Such auxiliaries can include one or more of tooth-mounted attachments, elastics, wires, springs, bite blocks, arch expanders, wire-and-bracket appliances, shell appliances, headgear, or any other orthodontic device or system that can be used in conjunction with the orthodontic appliances herein. The use of such auxiliary components may be advantageous in situations where it is difficult for the appliance alone to produce the force system. Additionally, auxiliary components can be added to the orthodontic appliance in order to provide other desired functionalities besides producing the force system, such as mandibular advancement splints to treat sleep apnea, pontics to improve aesthetic appearance, and so on. In some embodiments, the auxiliary components are fabricated and provided separately from the orthodontic appliance. Alternatively, the geometry of the orthodontic appliance can be modified to include one or more auxiliary components as integrally formed components.

In step 240, instructions for fabrication of the orthodontic appliance having the appliance geometry and material composition are generated. The instructions can be configured to control a fabrication system or device in order to produce the orthodontic appliance with the specified appliance geometry and material composition. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.). Optionally, the instructions can be configured to cause a fabrication machine to directly fabricate the orthodontic appliance with teeth receiving cavities having variable gable bends, as discussed above and herein. In alternative embodiments, the instructions can be configured for indirect fabrication of the appliance, e.g., by thermoforming.

Although the above steps show a method 200 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 200 may be performed with any suitable fabrication system or device, such as the embodiments described herein. Some of the steps may be optional, and the order of the steps can be varied as desired. For instance, in some embodiments, step 220 is optional, such that step 230 involves determining the appliance geometry and/or material composition based directly on the tooth movement path rather than based on the force system.

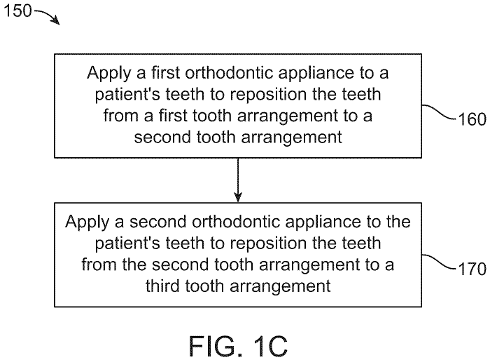

FIG. 3 illustrates a method 300 for digitally planning an orthodontic treatment and/or design or fabrication of an appliance, in accordance with embodiments. The method 300 can be applied to any of the treatment procedures described herein and can be performed by any suitable data processing system.

In step 310, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 320, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 330, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 3, design and/or fabrication of an orthodontic appliance, and perhaps a particular orthodontic treatment, may include use of a representation of the patient's teeth (e.g., receive a digital representation of the patient's teeth 310), followed by design and/or fabrication of an orthodontic appliance based on a representation of the patient's teeth in the arrangement represented by the received representation.

Optionally, some or all of the steps of the method 300 are performed locally at the site where the patient is being treated and during a single patient visit, referred to herein as “chair side manufacturing.” Chair side manufacturing can involve, for example, scanning the patient's teeth, automatically generating a treatment plan with treatment stages, and immediately fabricating one or more orthodontic appliance(s) to treat the patient using a chair side direct fabrication machine, all at the treating professional's office during a single appointment. In embodiments where a series of appliances are used to treat the patient, the first appliance may be produced chair side for immediate delivery to the patient, with the remaining appliances produced separately (e.g., off site at a lab or central manufacturing facility) and delivered at a later time (e.g., at a follow up appointment, mailed to the patient). Alternatively, the methods herein can accommodate production and immediate delivery of the entire series of appliances on site during a single visit. Chair side manufacturing can thus improve the convenience and speed of the treatment procedure by allowing the patient to immediately begin treatment at the practitioner's office, rather than having to wait for fabrication and delivery of the appliances at a later date. Additionally, chair side manufacturing can provide improved flexibility and efficiency of orthodontic treatment. For instance, in some embodiments, the patient is re-scanned at each appointment to determine the actual positions of the teeth, and the treatment plan is updated accordingly. Subsequently, new appliances can be immediately produced and delivered chair side to accommodate any changes to or deviations from the treatment plan.

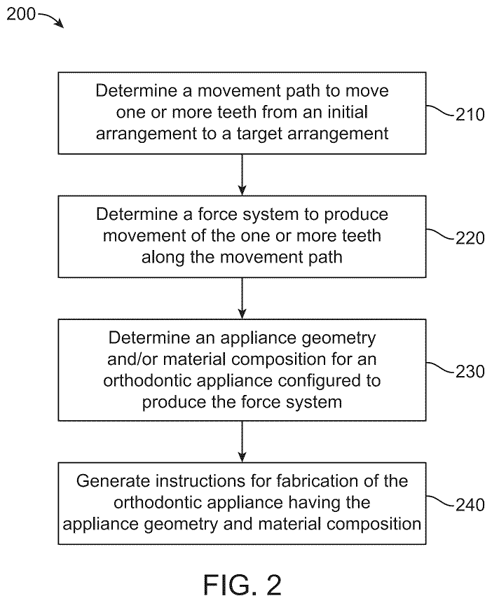

FIG. 4 is a simplified block diagram of a data processing system 400 that may be used in executing methods and processes described herein. The data processing system 400 typically includes at least one processor 402 that communicates with one or more peripheral devices via bus subsystem 404. These peripheral devices typically include a storage subsystem 406 (memory subsystem 408 and file storage subsystem 414), a set of user interface input and output devices 418, and an interface to outside networks 416. This interface is shown schematically as “Network Interface” block 416 and is coupled to corresponding interface devices in other data processing systems via communication network interface 424. Data processing system 400 can include, for example, one or more computers, such as a personal computer, workstation, mainframe, laptop, and the like.

The user interface input devices 418 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 406 maintains the basic required programming, including computer readable media having instructions (e.g., operating instructions, etc.), and data constructs. The program modules discussed herein are typically stored in storage subsystem 406. Storage subsystem 406 typically includes memory subsystem 408 and file storage subsystem 414. Memory subsystem 408 typically includes a number of memories (e.g., RAM 410, ROM 412, etc.) including computer readable memory for storage of fixed instructions, instructions and data during program execution, basic input/output system, etc. File storage subsystem 414 provides persistent (non-volatile) storage for program and data files and can include one or more removable or fixed drives or media, hard disk, floppy disk, CD-ROM, DVD, optical drives, and the like. One or more of the storage systems, drives, etc may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 420 includes any means for obtaining a digital representation (e.g., images, surface topography data, etc.) of a patient's teeth (e.g., by scanning physical models of the teeth such as casts 421, by scanning impressions taken of the teeth, or by directly scanning the intraoral cavity), which can be obtained either from the patient or from treating professional, such as an orthodontist, and includes means of providing the digital representation to data processing system 400 for further processing. Scanner 420 may be located at a location remote with respect to other components of the system and can communicate image data and/or information to data processing system 400, for example, via a network interface 424. Fabrication system 422 fabricates appliances 423 based on a treatment plan, including data set information received from data processing system 400. Fabrication machine 422 can, for example, be located at a remote location and receive data set information from data processing system 400 via network interface 424.

The data processing aspects of the methods described herein can be implemented in digital electronic circuitry, or in computer hardware, firmware, software, or suitable combinations thereof. Data processing apparatus can be implemented in a computer program product tangibly embodied in a machine-readable storage device for execution by a programmable processor. Data processing steps can be performed by a programmable processor executing program instructions to perform functions by operating on input data and generating output. The data processing aspects can be implemented in one or more computer programs that are executable on a programmable system, the system including one or more programmable processors operably coupled to a data storage system. Generally, a processor will receive instructions and data from a read-only memory and/or a random access memory. Storage devices suitable for tangibly embodying computer program instructions and data include all forms of nonvolatile memory, such as: semiconductor memory devices, such as EPROM, EEPROM, and flash memory devices; magnetic disks such as internal hard disks and removable disks; magneto-optical disks; and CD-ROM disks.

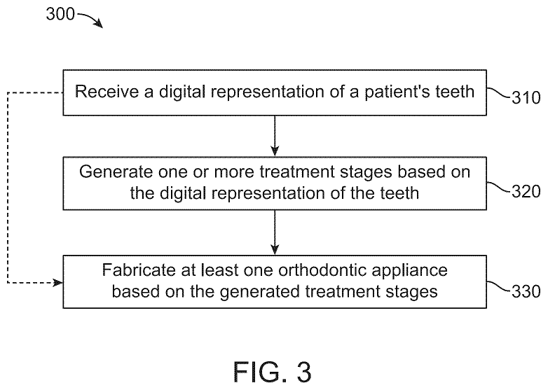

Referring now to FIG. 5, a digital or physical model of a jaw 502 is shown. The jaw 502 includes a plurality of teeth 506 and gingiva 504, as is the case with most people. However, in many people, the arrangement of teeth 506 may include one or more teeth having positions and orientations that deviate from their optimum positions, thereby possibly forming an improper occlusion (malocclusion). Where significant deviations from optimal positions exist for one or more teeth 506, orthodontics treatment is often employed to move the teeth towards their optimal positions.

In wire and bracket orthodontics, gable bends are incorporated into a variety of loop configurations to provide moment and forces to teeth in the controlled closing of space between individual teeth of groups of teeth. Similarly, a gable bend may be incorporated into a tooth receiving cavity of an aligner, such as the tooth receiving cavity 510 of the aligner 500 for the movement of the tooth 506. As discussed above, tooth receiving cavities, such as tooth receiving cavity 510 has a shape that is based on the shape of a corresponding tooth, such as tooth 506.

When implementing a gable bend into the aligner 500, the tooth receiving cavity 510 is rotated about a center of rotation 520. In a fixed, or standard, gable bend each portion of the tooth receiving cavity is rotated a fixed, linear, amount, such as 5 degrees, about the center of rotation 520. Fixed gable bends can be used in aligners to counteract a tipping force or moment that is imparted on the tooth by forces used to translate or more the position of the tooth. The aligners generally only impart forces on the crown of the tooth, which may be offset from the center of rotation of the tooth itself. Such offset forces impart a moment or tipping force on the tooth. A fixed gable bend generally imparts a force that counteracts the undesirable tipping force on the tooth due to translational forces that are offset from the center of rotation of the tooth.

FIG. 5 illustrates some of the drawbacks of implementing such a fixed gable bend. For example, as shown in FIG. 5, the entrance 518 of the tooth receiving cavity 510 is shifted far to the left in the figure and is shifted a distance D, relative to the tooth. The large displacement caused by the rotation causes problems when attempting to fit the aligner 500 is placed on a patient's jaw. In order for the aligner 500 to fit on the patient's teeth, the tooth receiving cavity 510 is significantly distorted. In some embodiments, the deformation of the aligner near the tooth receiving cavity 510 with the gable bend may be such that unwanted forces are imparted on nearby or adjacent teeth. In some embodiments, the tooth receiving cavity 510 may not even fit on the patent's teeth because the aligner may not be able to distort or deform enough to fit over the patient's teeth. In such embodiments, in order for the aligner 500 to fit over the patient's tooth, a dental practitioner may use a less aggressive gable bend that imparts less force onto the tooth than otherwise desired or proper. Such less aggressive fixed gable bends may result in the practitioner prescribing a longer treatment time than would be available if more aggressive gable bends with higher forces were available.

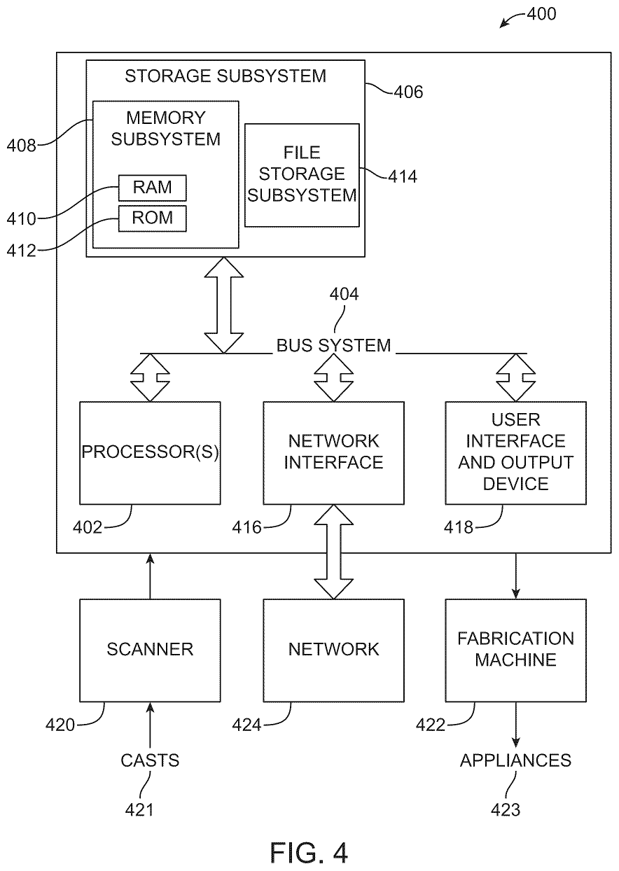

Referring now to FIG. 6, a digital or physical model of a jaw 602 is shown. The jaw 602 includes a plurality of teeth 606 and gingiva 604. An aligner 600 is shown overlaid over the jaw 602.

The aligner 600 includes a variable gable bend incorporated into a tooth receiving cavity 610 of the aligner 600 for the movement of the tooth 606. As discussed above, tooth receiving cavities, such as tooth receiving cavity 610 has a shape that is based on the shape of a corresponding tooth, such as tooth 606. When implementing a variable gable bend into the aligner 600, the tooth receiving cavity 610 may be rotated about a center of rotation 620. In a variable gable bend, the amount of rotation about the center of rotation 620 may vary. For example, in some embodiments, the rotation of the tooth receiving cavity may vary as a function of distance from the center of rotation 620, increasing or decreasing as the distance from the center of rotation increases. For example, at the center of rotation the tooth receiving cavity may be rotated 1 degree and the amount of rotation may increase to 3 degrees at the portion of the tooth receiving cavity furthest from the center of rotation. The amount by which the rotation increases or decreases may vary linearly with respect to the distance from the center of rotation, thereby creating a variable, e.g., non-fixed, amount of rotation.

In some embodiments, the amount of rotation may vary as a function of distance from the center of rotation 620 along an axis 622 that extends along the length of the tooth 606 from the root to the crown.

In some embodiments, a variable gable bend may include one or more of linear displacement and variable rotation. For example, a lower portion 612 of the tooth receiving cavity 610 may be linearly shifted a distance D, while the upper portion 614 of the tooth receiving cavity is variably rotated about the center of rotation 620. For example, in some embodiments, the rotation of the tooth receiving cavity may vary as a function of distance from the center of rotation 620, increasing or decreasing as the distance from the center of rotation increases. For example, at the center of rotation the tooth receiving cavity may be rotated 1 degree and the amount of rotation may increase to 3 degrees at the portion of the tooth receiving cavity furthest from the center of rotation.

In some embodiments, a gable bend may be implemented as a series of displacements that vary as a function of distance from a center of rotation or reference location 620. For example, a lower portion 612 of the tooth receiving cavity may be displaced a fixed amount while the upper portion 614 of the tooth receiving cavity may be displaced an amount that varies as a function of position along an axis that extends along the length of the tooth 606 from the root to the crown, for example axis 622. In the embodiment shown in FIG. 6, the entrance 618 of the tooth receiving cavity 610 is shifted or displaced to the left as compared to the position of the tooth 606. The upper portion of the tooth receiving cavity 610 is shifted or displaced rightward. The rate of displacement change as a function of distance along the axis 622 may increase as the position along the axis 622 approaches the crown of the tooth receiving cavity 610, as shown in FIG. 6. In some embodiments, the displacement may vary linearly or variably along the axis 622.

As shown in FIG. 6 the magnitude of the displacement D of an entrance 618 of the tooth receiving cavity 610 is shifted to the left in the figure a distance D, relative to the position of the tooth. By implementing the variable gable bend for the tooth receiving cavity 610, a dental practitioner is able to impart similar forces to the tooth 606 with the aligner 600, as the aligner 500 imparts on tooth 506, but the tooth receiving cavity 610 is shaped with an entrance 618 such that the aligner fits more easily on the patient's tooth because the displacement D in FIG. 5 is less than the displacement D in FIG. 6.

Such enhanced or variable gable bends can also impart both the translational forces to move the tooth and rotational forces to counter act the movement imparted by the translation forces and thereby aid in causing the tooth to translate without rotation or to aid in mitigating unwanted rotation or tipping of the tooth.

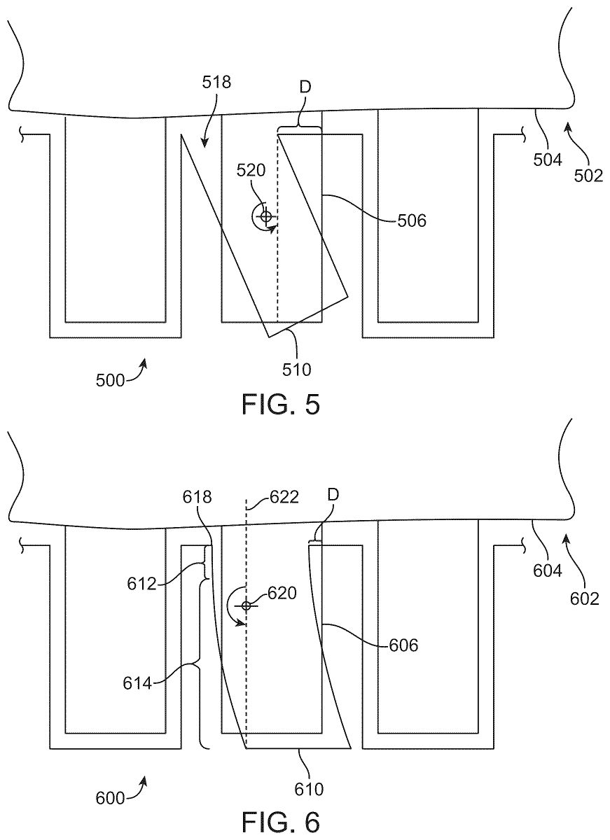

FIGS. 7A-7C show a tooth 700 along with embodiments of enhanced gable bends on the crown of the tooth. Gable bends in wire and bracket appliances rotate a patient's tooth about a fixed location on a patient's tooth at the bracket. The bracket is affixed to the patients tooth and the wire imparts the forces created by the gable bend in the wire to the tooth at the bracket. With an enhanced gable bend, such as the variable gable bends disclosed herein, a dental practitioner can locate the center of rotation of a gable bend in many different locations, which may not possible with traditional technology. For example, in FIGS. 7A-7C, a digital representation of a portion of a patient's tooth 710 is shown with a center of rotation 712 near or at the base of crown the tooth. Such a center of rotation is not possible with wire and bracket technology because the size and shape of the bracket precludes it from being positioned so close to the gingiva or gum line.

Also in FIGS. 7A-7C, a digital representation of a portion of a patient's tooth 720 or a tooth receiving cavity is shown with a center of rotation 722 near the crown of the tooth and rotated clockwise. Such a center of rotation is not possible with wire and bracket technology because the size and shape of the bracket precludes it from being positioned at or near the tip of the tooth.

In some embodiments, the center of rotation may be located at other positions, such as at a position on a root of the tooth, at a position on an adjacent tooth, or at a position outside the tooth or the tooth receiving cavity to which the gable bend is applied. In some embodiments, the center of ration may be in front of (e.g., in a facial, labial, or vestibular direction) or behind the tooth (e.g., in a buccal direction), for example, when moving the tooth in facial, labial, vestibular, or buccal directions.

In some embodiments, multiple aligners in a single set or for a single patient may include gable bends in a tooth receiving cavity that have centers of rotation that vary from aligner to aligner. This would, for example, allow a dental practitioner to adjust the center of rotation for a gable bend in a tooth during the course of treatment.

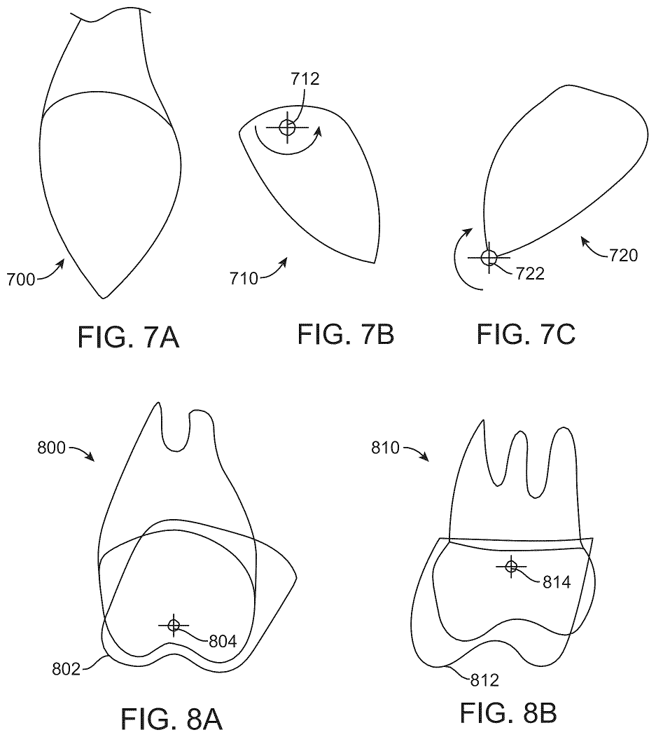

FIGS. 8A-8B shows a digital representation of two teeth 800, 810 along with embodiments of digital representations of tooth receiving cavity shapes with enhanced gable bends. A first digital representation of the of a cavity 802 is rotated about a center of rotation 804 near the top or occlusal surface of the crown of the tooth 800 with the amount of displacement of the tooth receiving cavity 802 increasing along the cavity, towards the base of the tooth.

A second digital representation of a cavity 812 is rotated about a center of rotation 814 that is located near the base of the crown of the tooth 810 with the amount of displacement of the tooth receiving cavity 812 increasing along the cavity towards the crown.

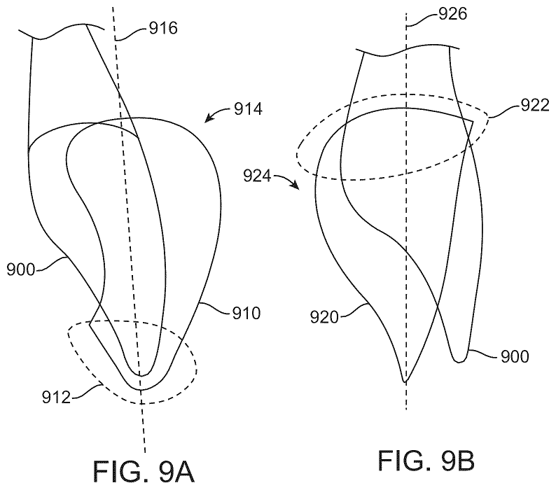

FIGS. 9A-9B shows a digital representation a tooth 900 along with embodiments of enhanced gable bends imparted on the crowns of tooth 900. A digital representation of a tooth cavity 910 is shown with two portions. A first portion 912 and a second portion 914. The first portion 912 of the digital representation of a tooth cavity 910 does not include a gable bend and is not rotated or shifted about the center of rotation 916 while the second portion 912 includes a gable bend and is shifted to the right as a function of position along the axis 916. Such an arrangement of a tooth receiving cavity does not change the overall tooth location relative to the aligner of which it is a part while still imparting repositioning forces onto the tooth.

The second embodiment shown in FIGS. 9A-9B includes the tooth 900 and a second digital representation of a tooth cavity 920 that includes a first portion 922 that does not include a gable bend and is not rotated or shifted while the second portion 924 includes a gable bend and is shifted to the left as a function of position along the axis 926. Such an arrangement of a tooth receiving cavity also does not change the overall tooth location relative to the aligner of which it is a part while still imparting repositioning forces onto the tooth.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

1. (canceled)

2. A computer-implemented method for generating one or more orthodontic appliances for treating a patient's teeth, the method comprising:
modeling a movement path to move a tooth of the patient from an initial arrangement towards a target arrangement;
mapping a location on the tooth of a center of rotation of a variable gable bend of the one or more orthodontic appliances configured to generate at least a portion of the movement path of the tooth when the one or more orthodontic appliances having the variable gable bend are in contact with the tooth;
designing a geometry for a tooth receiving cavity of the one or more orthodontic appliances based at least in part on the mapped location of the center of rotation on the tooth and the variable gable bend;
generating instructions for fabricating the one or more orthodontic appliances having a tooth receiving cavity formed according to the geometry for the tooth receiving cavity; and
transmitting the instructions for fabricating the one or more orthodontic appliances to an orthodontic appliance fabrication machine.

3. The computer-implemented method of claim 2, further comprising generating one or more digital models of at least a portion of the tooth.

4. The computer-implemented method of claim 3, wherein mapping the location on the tooth of the center of rotation comprises mapping one or more digital locations of the center of rotation on the one or more digital models of the at least portion of the tooth.

5. The computer-implemented method of claim 4, wherein mapping the location on the tooth of the center of rotation further comprises selecting a digital location of the one or more digital locations of the center of rotation.

6. The computer-implemented method of claim 5, wherein modeling the movement path comprises determining a force system to move the tooth from the initial arrangement towards the target arrangement.

7. The computer-implemented method of claim 6, wherein the force system comprises one or more forces and one or more torques.

8. The computer-implemented method of claim 7, further comprising generating one or more digital models of the one or more orthodontic appliances.

9. The computer-implemented method of claim 8, wherein the one or more digital models of the one or more orthodontic appliances comprise one or more digital models of the tooth receiving cavity of the one or more orthodontic appliances.

10. The computer-implemented method of claim 9, wherein designing the geometry for the tooth receiving cavity of the one or more orthodontic appliances comprises designing the geometry of the one or more digital models of the tooth receiving cavity to generate the one or more forces or the one or more torques, or both, when the one or more orthodontic appliances having the variable gable bend are in contact with the tooth.

11. The computer-implemented method of claim 10, wherein designing the geometry of the tooth receiving cavity further comprises varying rotation of one or more points of the geometry of the one or more digital models of the tooth receiving cavity based at least in part on the variable gable bend to generate the one or more forces or the one or more torques.

12. The computer-implemented method of claim 11, wherein varying rotation of one or more points of the geometry of the one or more digital models of the tooth receiving cavity comprises designing a first point of the tooth receiving cavity geometry to have a different degree of rotation than a second point of the tooth receiving cavity geometry.

13. The computer-implemented method of claim 12, wherein the rotation of the one or more points of the geometry of the one or more digital models of the tooth receiving cavity varies as a function of distance from the center of rotation along an axis of the center of rotation.

14. The computer-implemented method of claim 13, wherein designing the geometry of the tooth receiving cavity further comprises varying a distance of the one or more points of the geometry of the one or more digital models of the tooth receiving cavity from the axis of the center of rotation based at least in part on the variable gable bend to generate the one or more forces or the one or more torques.

15. The computer-implemented method of claim 14, wherein the distance of each point of the one or more points of the geometry of the one or more digital models of the tooth receiving cavity from the axis of the center of rotation comprises a displacement.

16. The computer-implemented method of claim 15, wherein the geometry for the one or more digital models of the tooth receiving cavity comprises one or more displacements configured to generate the one or more forces or the one or more torques, or both, when the one or more orthodontic appliances having the variable gable bend are in contact with the tooth.

17. The computer-implemented method of claim 16, wherein designing the geometry of the one or more digital models of the tooth receiving cavity further comprises utilizing the variable gable bend to generate a plurality of displacements of the geometry of the one or more digital models of the tooth receiving cavity, wherein the plurality of displacements varies in distance from the axis of the center of rotation.

18. The computer-implemented method of claim 17, wherein the plurality of displacements varies as a function of distance from the center of rotation.

19. The computer-implemented method of claim 18, further comprising modifying the design of the geometry of the one or more digital models of the tooth receiving cavity to modify the one or more forces or the one or more torques generated by the geometry of the tooth receiving cavity.

20. The computer-implemented method of claim 19, wherein modifying the design of the geometry of the one or more digital models of the tooth receiving cavity comprises selecting a different digital location of the center of rotation from the one or more digital locations of the center of rotation on the one or more digital models of the at least portion of the tooth.

21. The computer-implemented method of claim 20, wherein the one or more digital locations of the center of rotation on the one or more digital models of the at least portion of the tooth comprise one or more of: a location near the crown area of the tooth, a location near the gingiva of the tooth, a location near the root of the tooth, a location on an adjacent tooth, a location external to the area of the tooth, in front of the tooth, behind the tooth, or any combination thereof.
